(19) United States
(12) Patent Application Publication
(10) Pub. No.: US 2016/0173404 A1
(43) Pub. Date: Jun. 16, 2016

(54) METHOD TO JOINTLY SELECT CLOUD COMPUTING AND NETWORK SERVICES AND ASSOCIATED DEVICE

(71) Applicant: THALES, Courbevoie (FR)

(72) Inventors: Helia Pouyllau, Palaiseau (FR); Emmanuel Dotaro, Palaiseau (FR); Mario Lopez-Ramos, Gennevilliers (FR)

(21) Appl. No.: 14/969,618

(22) Filed: Dec. 15, 2015

(30) Foreign Application Priority Data
Dec. 15, 2014 (FR) 1402857

(51) Int. Cl. H04L 12/911; H04L 29/08; G06F 17/30; H04L 12/24

(52) U.S. Cl. CPC H04L 47/70; H04L 41/5019; H04L 41/5003; H04L 67/16; G06F 17/3053

(57) ABSTRACT

A selection method for selecting at least one service among a plurality of predetermined services including the following steps: receiving by the computation software application of a service request input by a service requester, the service request including at least one component relative to the services and an indication relating to a level of satisfaction expected; development by the computation software application of a set of candidates, each candidate including a plurality of services, each service of each candidate being capable of satisfying at least one component of the service request; evaluation of each candidate by the computation software application, which includes the calculation of an overall score for the candidate by means of a predetermined cost function, as a function of the level of satisfaction expected; and allocation to the service requester of the services of the candidate that optimizes the cost function.

This application claims benefit of French Patent Application No. 14 02857 filed on Dec. 15, 2014, the disclosure of which are incorporated herein by reference.

The present invention relates to a selection method for selecting at least one service among a plurality of predetermined services that are appropriate for being provided by at least one service provider, the said services constituting at least a part of a telecommunications network, one part of the services being the nodes of the telecommunications network and one other part of the services being the links between the said nodes, each service comprising at least one attribute, the method being operationally implemented by a computer including a computation software application.

The invention is applicable to the field of telecommunications networks, in particular to the provision of services, by a telecommunications network, to a set of service requesters, following a request made by at least one service requester. For example, the invention is applicable to services provided by a dematerialised cloud computing network (for example, capable of providing software services, computing services or storage services), as well as to security services (for example, a level of security or a function of ensuring security that is appropriate for a network provider to provide), or even network services (for example connectivity services having guaranteed characteristic features).

The services are provided by the resources from the telecommunications network, for example network resources or service request resources, such as virtual machines, storage spaces, or even network links.

The term “service requester” is understood to refer to a user of a telecommunications network who is capable of inputting a service request in order to request the allocation of at least one service by the telecommunications network.

It is a known practice to provide network services, from among a set of available network services, to a service requester who has input a service request defining their needs in terms of services. For example, it is known to make use of algorithms that are capable of determining a solution, consisting of a set of services that respond to the service request of the service requester.

However, such algorithms are not able to take into account a level of satisfaction required by the service requester, in particular in contexts that present strong requirements related to the security of networks, to the integrity and confidentiality of information passing through over these networks, and to the load of different resources of the networks.

In other words, the conventional algorithms are not capable of taking into account the level of satisfaction required by the service requester, in particular in contexts that present requirements related to priority and security. However, in certain contexts of use, it is essential to assign requirements related to security (for example an encryption function or even an availability level over time of a resource) and dependence (for example, an exclusion requirements related to geographical placement among resources), associated with performance related requirements (for example a response time, or even a throughput or bit rate), and to ensure that these requirements are satisfied as best as possible.

A goal of the invention is to provide a method for selecting at least one service that is capable of handling and processing the service requests of a user and of taking into account the level of satisfaction with a quality of service expected by the said service requester, for example, and in a non-exclusive fashion, with regard to security and priority requirements relative to the services provided by a telecommunications network.

To this end the object of the invention relates to a method of the aforementioned type, including the following steps of:
receiving by a computation software application of a service request input by a service requester, the service request including at least one component relative to the services, the service request in addition including an indication relating to a level of satisfaction expected relating to the satisfaction of at least one attribute of a component of the service request;
for each component of the service request, identification by a computation software application of the services that are best suited to satisfying the said component;
development by the computation software application of a set of candidates, each candidate including a plurality of services, each service of each candidate being capable of satisfying at least one component of the service request;
evaluation of each candidate by the computation software application, the evaluation including:
   for each service, the calculation of a rate of satisfaction of each of the attributes of the service with regard to the service request, by means of a mode of calculation of predetermined satisfaction rate;
   the calculation of an overall score for the candidate by means of a predetermined cost function, as a function of the satisfaction rate of at least one service of the candidate with regard to the level of satisfaction expected;
identification of the candidate for which the cost function attains an optimum;
allocation to the service requester of the services of the candidate that optimizes the cost function.

Indeed, such a selection method provides the ability to find a solution to this service request by taking into account the level of satisfaction expected, for example with regard to requirements of security and priority, by the implementation of a calculation of overall score taking into account a satisfaction rate offered by a candidate with regard to the service request of the service requester.

In accordance with other advantageous aspects of the invention, the method includes one or more of the following characteristic features, taken into consideration individually or according to all technically possible combinations:
a link is a data transport service and characterised in that a node is a storage service and/or a computation service and/or an application-based service;
the services are identified and listed in a catalogue, the number of services and/or the attributes of services are likely to vary over the course of time;
the or each service provider has allocated services and unallocated services, the service request contains an information item relating to the priority of the said service request, the method in addition including the following steps of:
   identification of the services allocated following as a result of previous service requests from among the plurality of services;
   first search, for the or each component of the service request, to ascertain the existence, among the unallocated services, of services that satisfy the component;
   if, among the unallocated services, there does not exist any service that satisfies at least a first component of the service request, for each first component of the service request, second search to ascertain the existence of services that satisfy the first component among the services allocated to previous service requests having a priority that is lower than or equal to the priority of the new service request;
   deallocation of all or part of the allocated services that satisfy the first component of the service request;
at least one service presents an attribute selected from among the set consisting of: the time period, the bandwidth, the throughput or bit rate, the jitter, loss rate, the storage space, the frequency of computation of the processor, the availability, the robustness factor, the provider of the service, the location of the resource capable of providing the service, the cost of configuration of the service and the price; or a security attribute selected from the set consisting of: the level of security, the characteristic features of the encryption algorithm, the characteristic features of the authentication algorithm, the characteristic features of the confidentiality algorithm, the country or countries, regions and/or service providers excluded, and the size of the encryption key;
the step of development of a set of candidates includes the random generation of each candidate, each service for each candidate satisfying the corresponding component of the service request;
the method includes the step of writing the connectivity links existing between the various services, to a memory location;
the service request includes at least one constraint forming a condition relative to the services corresponding to at least two distinct components of the said service request;
the constraints associated with at least two components of the service request include the constraints relating to the links between the nodes corresponding to each component, and/or the constraints of relative placement between the links and/or the nodes corresponding to each component;
the step of development of a set of candidates includes:
   the selection of a predetermined percentage of candidates from among the candidates for which the cost function is the closest possible to an optimum, in order to form a parent-generation of candidates;
   the computation of at least one new candidate from at least one candidate from the parent-generation, the computing including:
      the selection of a candidate from the parent-generation;
      for each service of the candidate selected from the parent-generation, associated with a component of the service request that does not include a constraint, the replacement of the service by a service selected in a random manner from among the services that satisfy the component;
      for every other service, the replacement of the service by a service selected in a random manner from among the services that satisfy at least the same constraints of the component as the corresponding service of the candidate selected from the parent-generation;
the evaluation step includes the penalization of the overall score of a candidate if at least one constraint is not satisfied by a service of the candidate;
the evaluation step includes the penalization of the overall score of a candidate if, for at least one constraint that is not satisfied by a service of the candidate, the difference between the expected level of satisfaction and the level of satisfaction provided by the said service is greater than or equal to a threshold value, the threshold being defined by the service requester or calculated in accordance with the predetermined rules;
the method includes in addition, for each service, a step of writing to a memory location:
   for each attribute, of a mode of calculation of a rate of satisfaction;
   for each attribute, of a utility function for the calculation of a score for the attribute for a given value of the satisfaction rate;
   for each attribute, of a suitable specific weight;
   for each n-tuple of attributes, of a joint weight;
   of the cost function, the cost function being of the following form:

$$C ( X ) = {\sum }_{I ( \{ i , j \} ) < 0} min ( {u}_{i} ( {x}_{i} ) {u}_{j} ( {x}_{j} ) ) \cdot I ( \{ i , j \} ) + {\sum }_{I ( \{ i , j \} ) < 0} max ( {u}_{i} ( {x}_{i} ) {u}_{j} ( {x}_{j} ) ) \cdot \vert I ( \{ i , j \} ) \vert + {\sum }_{i = 1}^{n} {u}_{i} ( {x}_{i} ) \cdot ( {φ}_{i} - \frac{1}{2} {\sum }_{j \neq i} \vert I ( \{ i , j \} ) \vert )$$

where min is the minimum operator, max is the maximum operator, X is a vector associated with a candidate, each element of the vector X corresponding to a service of the candidate and being equal to the rate of satisfaction of a component of the service request by the corresponding service, where xᵢ, xⱼ are respectively the rate of satisfaction of the component relative to the attribute i and of the component relative to the attribute j, and where uᵢ, is the utility function relative to the attribute i, Φᵢ is the specific weight relative to the attribute i, I({i,j}) the joint weight relative to the attributes i, j and |I({i,j})| denotes the absolute value of the joint weight I({i,j}).

The object of the invention also relates to a selection device for selecting at least one service to be provided by a telecommunications network from among a plurality of predetermined services and each comprising at least one attribute, the device comprising the computing means associated with the storage means in order to operationally implement the method as defined here above.

The invention will be better understood with the aid of the description that will follow, provided only by way of non-limiting example and with reference made to the attached drawings in which:

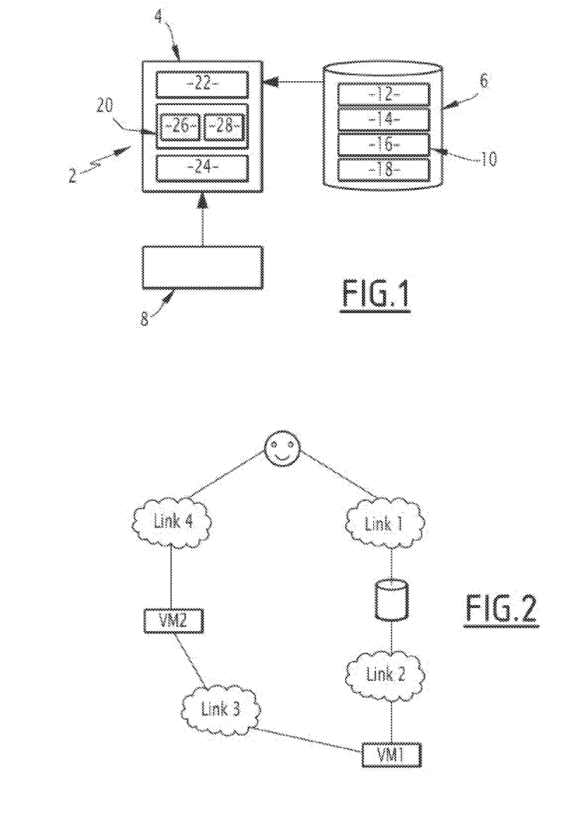

FIG. 1 is a schematic representation of a device according to the invention;

FIG. 2 is a schematic representation of a configuration of network services corresponding to a service request expressed by a service requester;

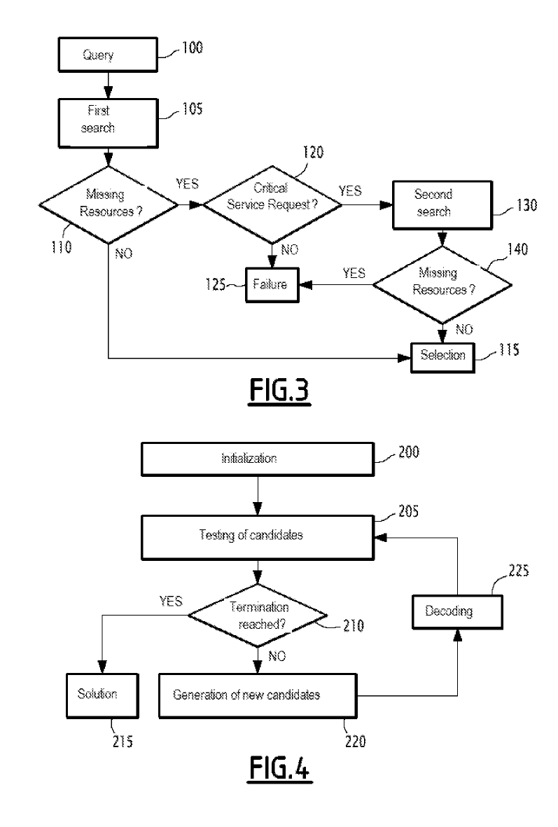

FIG. 3 is a flow chart of a first part of a method of computation of a solution according to the invention; and

FIG. 4 is a flowchart of a second part of the method shown in FIG. 3.

Represented in FIG. 1 is a selection device 2 for selecting at least one service according to the invention.

The device 2 is capable of receiving a service request relating to the services and of computing/calculating, from among a plurality of services accessible via a telecommunications network, a solution consisting of a set of services that satisfy the service request.

The services form at least one part of the telecommunications network, with one part of the services being the nodes of the telecommunications network and another part of the services being the links between the said nodes.

A link is preferably a data transport service. In addition, a node is preferably a storage service, a computation service of or even an application based service.

The said links and the said nodes are for example provided by the providers of services, and are identified and listed in a catalogue. The properties of the services as well as the number thereof are quite likely to vary over the course of time.

The term “service request” is understood to refer to a set of conditions determined by a service requester, which define at least one service that the service requester wishes to avail of, as well as, for all or part of the services, a level of satisfaction desired for the or each service.

For example, as illustrated in FIG. 2, following a service request from a service requester, the device 2 is capable of selecting a first virtual machine VM1, a second machine virtual VM2, and a storage space, connected to each other and to the service requester by the network links Link 1, Link 2, Link 3, and Link 4.

The first virtual machine VM1, the second virtual machine VM2 and the storage space are the nodes of the network, while the network links Link 1, Link 2, Link 3, and Link 4 are links of the network.

As shown in FIG. 1, the device 2 includes a data processing unit 4, which forms the computing means, connected to a database 6, which forms the storage means, and a data input interface 8.

The data processing unit 4 is capable of computing a solution to respond to a service request input by a service requester via the data input interface 8. The database 6 is adapted for storing a plurality of tables 10.

The database 6 includes a table of services 12, a table 14 of allocated services, a table 16 of connectivity links, and a computation table 18.

The table of services 12 is adapted for storing a description of each service. Each description is specific to a corresponding service. Each service is identified by a unique identifier. Advantageously, the descriptive records stored in the table of services 12 present a structure that is independent of the service considered and common to all of the services.

Each descriptive record has a plurality of fields, with each field being relative to an attribute. The term “attribute”, is used to refer to one of the characteristic features that a service presents. The attributes of a service are for example, and in a non-limiting manner, the technical characteristic features of the service, such as a time period, a bandwidth, throughput or bit rate, the jitter, a loss rate, a storage space, a frequency of computation of the processor, the availability, a robustness factor, the provider of the service, the location of the resource capable of providing the service (that is to say, a country, a region or a provider), a cost of configuration of the service and a price.

In addition, the attributes of a service include, for example, and in a non-limiting manner, a level of security, the characteristic features of an encryption algorithm, the characteristic features of an authentication algorithm, the characteristic features of a confidentiality algorithm, a size for the encryption key, the country or countries, regions and/or service providers excluded. Such attributes are referred to as “security related”.

Each attribute is identified by a unique identifier.

For each service, the value taken by each attribute is specific to the service. For example, for a given service that does not have a given attribute, the corresponding field is left blank.

Each service belongs to a class of services. The services of the same class have common technical characteristic features. Such classes are for example, and in a non-limiting manner, security services, storage services, virtual machine related services, or even network connectivity services.

The table 14 of allocated services is capable of storing the identifier of the services allocated to the service requester or to other service requesters as a result of previous service requests.

Preferably, for each allocated service, the table 14 is adapted for storing the value of an indicator of the priority of the service request as a result of which the service has been allocated.

In an optional mannerly, for each allocated service, the table 14 is adapted for storing the load associated with the service, that is to say a measure of the use thereof.

The table 16 of connectivity links is capable of storing the network links existing between the various different services. For example, for each of the entries in the table of links 16, the table of links 16 includes a first field and a second field. The first field contains the identifier of a first service, and the second field includes the identifier of all of the second services for which there exists a network connectivity with the first service.

The contents of the computation table 18 will be described farther on.

Advantageously, 10 the tables 6 of the database are updated with each modification made to the catalogue of the or each services provider.

The data processing unit 4 includes a memory storage 20, a processor 22 and a transmitter-receiver 24. The memory storage 20 is capable of storing a plurality of software programmes. The processor 22 is capable of executing and running the software programmes stored in the memory storage 20. In particular, the memory storage 20 is capable of storing a reading software application 26 and a computation software application 28. The transmitter-receiver 24 is capable of receiving the service requests input via the input interface 8.

The data processing unit 4 is also connected to a telecommunications network so as to be able to identify the services that the network is capable of providing. The data processing unit 4 is additionally also is capable of determining the load associated with each service.

The reading software application 26 is capable of reading the contents of the database 6, in particular is capable of reading the contents of each of the tables 10 of the database 6. The computation software application 28 is capable of computing a solution, where it exists, to the service request input by the service requester via the data input interface 8.

Preferably, the computation software application 28 is capable of determining a solution, formed by a set of services, such that the load is distributed between the various different services. In particular, the computation software application 28 is capable of determining, for a given service request, a solution that minimizes the variance of the load on all of the services that satisfy the service request of the service requester.

Each service request includes a plurality of components. Each component is related to a class of desired services. For each component, each service request includes in addition at least one criterion. Each criterion is relative to the attributes expected for a service of the class associated with the said component.

In addition, each service request includes for example at least one constraint relative to at least two services.

The term “constraint”, is used, within the meaning of the present invention, to refer to a condition having a bearing on the value of an attribute that is common to at least two distinctly separate services.

For example, each service request includes at least one constraint relative to the connectivity between at least two services, or even to the relative placement of the resources providing at least two services.

For each criterion and for each constraint, the service request also includes the expected level of satisfaction, as well as an indication relating to whether or not the corresponding service demonstrates strict adherence to the expected level of satisfaction.

The term “service demonstrating a strictly expected satisfaction rate”, is used to refer to a service for which the service provided may not lead to a level of satisfaction value that is less than the value of the level of satisfaction requested.

By way of a variant, the indication relating to whether or not the corresponding service demonstrates strict adherence to the expected level of satisfaction, is determined by the device 2 in accordance with the rules as defined, for example by an administrator.

For example, the services deemed permissible would include those for which the difference between the expected level of satisfaction and the level of satisfaction provided by this service is less or equal to a threshold value, the threshold being defined by the service requester or calculated in accordance with the predetermined rules.

Each service request also includes an indicator of the priority of the service request. In addition, each service request includes an expected level of satisfaction by component and/or by group of components. For example, each service request also includes an objective, as will be defined subsequently.

During an initial step of configuration, each service is recorded in the table of services 12. In particular, each service is identified by a unique identifier, and associated with a descriptive record containing the values of the attributes of the service.

In addition, during the initial step, an administrator defines, for each attribute, the rules relating to the modes of calculation of the satisfaction of a criterion for a service request by a service or a plurality of services, such a satisfaction level being even referred to as “satisfaction rate”.

Such rules include for example the modes of calculation of the value for the attributes of a plurality of joint services. Such modes include for example:
the comparison of two values of attributes with each other: for example the use of the operators strictly greater, strictly lower, lower or equal, greater or equal;
the composition of two values of attributes therebetween: for example the addition, multiplication, the use of a maximum operator, the use of a minimum operator, etc.;
the decomposition of two values of attributes therebetween: for example subtraction, division, the use of a maximum operator, the use of a minimum operator, etc.

During the initial step, the administrator also defines a plurality of cost functions, which are even known as “objectives-functions”, such as will be defined subsequently, and a plurality of coefficients, and writes the functions and coefficients in the computation table 18.

The definition of an objective-function is as follows. For each attribute having the identifier i, the administrator defines a corresponding utility function uᵢ. Each utility function uᵢ has as variable a rate x^{k}ᵢ. The rate x^{k}ᵢ, even known as “rate of satisfaction”, is a measure, for the attribute having the identifier i of a service k, of the achievement of the expected level of satisfaction for a given criterion of the service request.

In addition, for each attribute i, the administrator writes in the calculation table 18 a weight Φᵢ specific to the attribute having the identifier i.

In addition, for each n-tuple {i, j, . . . } of attributes including at least two distinctly separate attributes i, j, the administrator writes in the calculation table 18 a joint weight I({i,j}).

The term “n-tuple”, is used to refer to a vector having the identifiers of at least two attributes of services.

The selection method for selecting at least one service according to the invention will now be described with regard to the FIGS. 3 and 4.

During the course of a step 100 of querying, the service requester inputs a service request via the data input interface 8. In an optional manner, the service requester chooses an objective-function from among the objective-functions predefined by the administrator. By way of a variant, the objective-function depends on the service requester and/or on the state of the system, according to a rule predetermined by the administrator.

For example, each service request is stored in the device 2 in the form of a vector of components, the position of each component in the said vector forming an identifier of the said component.

During a subsequent step of the first search 105, for each component of the service request, the reading software application 26 reads the table of services 12 and table 14 of allocated services.

For each unallocated service in the table of services 12, that is to say whose identifier is absent from the table 14 of allocated services, the computation software application 28 determines if the service is capable of satisfying the component considered, that is to say satisfying the component and the associated criteria.

In the course of a subsequent step 110 the computation software application 28 determines if, for each component, there exists at least one service among the services that have not been allocated that is capable of satisfying the component.

If, for each component, there exists at least one service among the services that have not been allocated that is capable of satisfying the component, then during a subsequent step 115 of selection, the computation software application 28 computes a combination of services that best satisfies the service request. The selection step 115 will be described subsequently.

If, for at least one component, even known as “unsatisfied component”, there does not exist any service among the unallocated services that is capable of satisfying the component with regard to the level of satisfaction expected by the service requester, or if, during the selection step 115 the computation software application 28 does not succeed in determining a combination of services that satisfy the service request then, during a subsequent step 120, the computation software application 28 determines if the value of the priority of the service request is greater than or equal to a predetermined threshold value.

If the value of the priority of the service request is lower than the predetermined threshold, then, during a subsequent step 125, the computation device 2 transmits an error message to be forwarded to the service requester.

If the value of the priority of the service request is greater than or equal to the threshold value, then, during the course of a subsequent step 130 of the second search, the reading software application 26 reads the table 14 of allocated services. The computation software application 28 determines if, for every unsatisfied component, there exists at least one service among the allocated services that is capable of satisfying the component. The computation software application 28 then retains, for the computation of a solution in response to the service request of the service requester, the or each service among the allocated services that is capable of satisfying the said component.

If there exists at least one unsatisfied component for which there does not exist any service among the unallocated services that is capable of satisfying the unsatisfied component, then, during a subsequent step 120, the computation device 2 transmits an error message in accordance with the step 125.

Advantageously, over the course of the second search step 130, the computation software application 28 sorts, in order of priority, the services for which an identifier is stored in the table 14 of allocated services. Then the computation software application 28, starting with the services allocated as a result of service requests for which the priority is lowest, searches the services that satisfy the unsatisfied components. The search step stops a soon as, for each component not satisfied, the computation software application 28 finds a service that satisfies the unsatisfied component among the services that have been allocated as a result of a service request for which the priority is lower than the priority of the current service request.

The selection step 115 will now be described with reference to FIG. 4.

During a step of initialization 200, the computation software application 28 creates a plurality of candidates that form a set known as “generation of candidates”.

The term “candidate” is used to refer to set of services representing a potential solution with regard to the service request of the service requester. Each candidate is for example an n-tuple containing at least one unique identifier of a service. In particular, each candidate, for each component of the service request, includes a unique identifier of a service satisfying the component of the service request and the associated criteria, also known as “candidate service”.

For example for a given component of the service request, the corresponding service of the candidate is selected in a random manner from among the services that satisfy the component and the associated criteria.

In particular, candidates are generated as follows. For each component of the service request, the computation software application 28 selects in a random manner a candidate service from among the services not allocated.

If, for the component considered, the service request includes constraints, then, for each other component, also known as “dependent component”, of the service request that has a relationship, via the constraint, with the component considered, then the computation software application 28 selects in a random manner a candidate service for the dependent component that satisfies the dependent component and the constraint.

Each candidate is for example stored in the device 2 in the form of a vector of unique identifiers of services. For example, the position of each element of the vector corresponds to the identifier of the corresponding component of the service request.

In addition, over the course of the initialization step 200, the computation software application 28 identifies the objective-function selected by the service requester. By way of a variant, the identification depends for example, on the service requester, on the state of the services, or any other policy defined by the administrator.

The objective-function is capable of calculating an overall score for each candidate. The objective-function integrates the utility functions uᵢ, the specific weights Φᵢ and the joint weights I({i, j, . . . }), related to the attributes i, j to which the service request pertains.

For example, the objective-function is written as follows:

$$C ( X ) = {\sum }_{I ( \{ i , j \} ) < 0} min ( {u}_{i} ( {x}_{i} ) ; {u}_{j} ( {x}_{j} ) ) \cdot I ( \{ i , j \} ) + {\sum }_{I ( \{ i , j \} ) < 0} max ( {u}_{i} ( {x}_{i} ) ; {u}_{j} ( {x}_{j} ) ) \cdot \vert I ( \{ i , j \} ) \vert + {\sum }_{i = 1}^{n} {u}_{i} ( {x}_{i} ) \cdot ( {φ}_{i} - \frac{1}{2} {\sum }_{j \neq i} \vert I ( \{ i , j \} ) \vert )$$

where min is the minimum operator, max is the maximum operator, X is a vector associated with a candidate, each element of the vector X corresponding to a service of the candidate and being equal to the rate of satisfaction of a criterion of the service request by the corresponding service, where xᵢ, xⱼ are respectively the rate of satisfaction of the component relating to the attribute i and of the component relating to the attribute j, and where uᵢ, is the utility function relating to the attribute i, Φᵢ is the specific weight relative to the attribute i, I({i,j}) the joint weight relative to the attributes i, j as defined previously and |I({i,j})| denotes the absolute value of the joint weight I({i,j}). Such an objective-function is also known as “Choquet integral”.

During a subsequent step 205 of testing, the computation software application 28 records and stores, for each candidate, the overall score determined during a step 225 that will be described subsequently. For example, the overall score is representative of the level of satisfaction of the criteria of the service request by the candidate and the value of the objective-function for the candidate. In particular, the computation software application 28 records and stores the candidate for which the objective-function reaches an optimum.

During the course of a subsequent step 210, if a predetermined termination rule is satisfied, then, during a final step 215, the selection device 2 transmits for example the candidate that optimizes the objective-function to an allocation unit for allocating the services (not shown).

If the candidate includes allocated services, the allocation unit deallocates all or part of the allocated services, and allocates them to the service requester who has input the service request.

Such a termination rule, for example, is the achievement of the level of satisfaction hoped for by the service requester. In addition, such a termination rule for example, is the achievement of a maximum number of calculation cycles. By way of a variant, such a termination rule is the achievement of a minimum relative variation of the value taken by the objective-function between the best overall solution (that is to say, the solution having the best objective-function score over all of the previous cycles) and the best solution found at the end of the current cycle.

If the termination rule has not been satisfied, then, during a subsequent step 220 the computation software application 28 creates a new plurality of candidates, also referred to as “child-generation”.

For example, the computation software application 28 creates at least one part of the candidates from the child-generation in accordance with the initialization step 200.

For example, the child-generation includes a predetermined percentage of candidates from the previous generation, known as the “parent-generation”. The candidates from the parent-generation who belong to the child-generation are those candidates whose overall score is better than the overall score of the other candidates in respect of the objective-function to be optimized.

Preferably at least one candidate from the child-generation depends on at least one candidate from the previous generation, also known as the “parent-generation”. For example, the computation software application 28 creates at least one candidate from the child-generation by modification of a candidate from the parent-generation, or by the crossing over of at least two candidates from the parent-generation.

The term “modification”, is used to refer to the arbitrary selection of a first service of the candidate and its replacement by a second service that also satisfies the very criterion or criteria, the satisfaction whereof is strictly expected, that the first service satisfies.

The term “crossing over”, is used to refer to the replacement of a plurality of services of a first candidate that satisfies the service request by the corresponding services of a second candidate that satisfies the service request.

The candidate creation algorithm for creating the candidates of the child-generation from the candidates of the parent-generation for example, is a conventionally known genetic algorithm.

During the course of a subsequent step 225 of decoding, the reading software application 26 reads the table of links 16, and the computation software application 28 determines, for each candidate from the child-generation, if the connectivity links between the services satisfy the constraints related to the corresponding components of the service request.

For example, the candidates whose services do not satisfy the connectivity related constraints of the service request, and/or the constraints for which the desired satisfaction rate is 100%, are penalized. For example, in the case of an objective-function to be optimized, a low overall score is attributed to such candidates.

Then the computation software application 28 calculates the overall score of each candidate in the child-generation. Thereafter, the computation software application 28 records and stores the said overall score, in accordance with the test step 205.

By way of a variant, during the course of the step 220, the modifications of the candidates takes into account the connectivity links recorded in the table of links 16.

The modifications and cross-overs take into account the constraints between the components of the service request.

For the modifications, if a first service to be replaced is associated with a component of the service request that has dependent components, then the first service is replaced by a second service that satisfies at least the same constraints related to the dependent components as the first service.

For the cross-overs, if each service of a first set of services to be replaced is associated with a component of the service request that has dependent components, then the first set of services is replaced by a second set of services, such that each service of the second set satisfies, for the corresponding component of the service request, at least the same constraints relating to the dependent components as the service associated with the first set of services.

By way of a variant, the candidate creation algorithm is a conventionally known ant colony optimization algorithm.

The selection method according to the invention makes it possible to effectively process requirements related to security, priority, and satisfaction by making use of the definition of modes of calculation of rate of satisfaction of the services in respect of a service request formulated by a service requester.

In addition, the solution provided upon conclusion of the method is optimal or quasi-optimal, due to the implementation of an objective-function, the solution provided being a solution that optimizes, whenever this is possible, the objective-function.

Moreover, the deallocation of the previously allocated services to the benefit of the service requests having a high priority level greatly enhances the chances of finding a suitable solution to satisfy a priority service request.

The operational implementation of constraints relating to the relationships between services provides the ability to promote or disadvantage certain candidates on the basis of a selection policy established by the service requester, for example a policy relating to the connectivity between services (for example, it not being desired by the service requester that all services be provided by a single telecommunications network provider) or even a policy relating to the placement (for example it not being desired by the service requester that a service be provided by an IT resource located in a particular given geographic region).

The implementation of a random generation of candidates allows for making available a wide variety of the said candidates, which increases the chances of convergence towards an optimal solution with regard to the objective-function.

The writing, to a memory location, of the connectivity links between the various different services makes possible the rapid treatment and processing of the said connectivity links, in particular at the time of the development of the candidate sets.

In addition, the saving and storage in the memory of such connectivity links also allows for the rapid treatment and processing of the constraints related to dependency. For example, during the generation of a new generation of candidates from a previous generation whose candidates satisfy the connectivity related constraints of the service request, the presence in the memory of the connectivity links makes it possible to create new candidates while maintaining the connectivity links of the candidates of the previous generation. This therefore makes possible a more rapid convergence towards an optimal solution while avoiding the generating of new candidates who do not satisfy the constraints related to connectivity, and which therefore do not represent potential solutions with respect to the service request.

In addition, the penalization of the overall score of a candidate if the dependency related constraints are not satisfied by at least one service of the candidate makes possible, in the implementation of genetic algorithms or ant colony optimization algorithms, a more rapid convergence towards a solution that satisfies the service request.

1. A selection method for selecting at least one service among a plurality of predetermined services provided by at least one service provider, the said services constituting at least a part of a telecommunications network, one part of the services being the nodes of the telecommunications network and one other part of the services being the links between the said nodes, each service comprising at least one attribute, the method being operationally implemented by a computer including a computation software application, wherein the selection method includes the following steps of:
receiving by the computation software application of a service request input by a service requester, the service request including at least one component relative to the services, the service request including in addition an indication relating to a level of satisfaction expected relating to the satisfaction of at least one attribute of a component of the service request;
for each component of the service request, identification by a computation software application of the services that are best suited to satisfying the said component;
development by the computation software application of a set of candidates, each candidate including a plurality of services, each service of each candidate being capable of satisfying at least one component of the service request;
evaluation of each candidate by the computation software application, the evaluation including:
for each service, the calculation of a rate of satisfaction of each of the attributes of the service with regard to the service request, using a mode of calculation of a predetermined satisfaction rate;
the calculation of an overall score for the candidate by means of a predetermined cost function, as a function of the satisfaction rate of at least one service of the candidate with regard to the level of satisfaction expected;
identification of the candidate for which the cost function attains an optimum;
allocation to the service requester of the services of the candidate that optimizes the cost function.

2. A method according to claim 1, wherein a link is a data transport service and in that a node is a storage service and/or a computation service and/or an application-based service.

3. A method according to claim 1, wherein the services are identified and listed in a catalogue, the number of services and/or the attributes of services are likely to vary over the course of time.

4. A method according to claim 1, wherein the or each service provider has allocated services and unallocated services, and in that the service request contains an information item relating to the priority of the said service request, the method in addition including the following steps of:
identification of the services allocated following as a result of previous service requests from among the plurality of services;
first search for the or each component of the service request, to ascertain the existence, among the unallocated services, of services that satisfy the component;
if, among the unallocated services, there does not exist any service that satisfies at least a first component of the service request, for each first component of the service request, second search to ascertain the existence of services that satisfy the first component among the services allocated to previous service requests having a priority that is lower than or equal to the priority of the new service request;
deallocation of all or part of the allocated services that satisfy the first component of the service request.

5. A method according to claim 1, wherein at least one service presents an attribute selected from among the set consisting of: the time period, the bandwidth, the throughput or bit rate, the jitter, loss rate, the storage space, the frequency of computation of the processor, the availability, the robustness factor, the provider of the service, the location of the resource capable of providing the service, the cost of configuration of the service and the price; or a security attribute selected from the set consisting of: the level of security, the characteristic features of the encryption algorithm, the characteristic features of the authentication algorithm, the characteristic features of the confidentiality algorithm, the country or countries, regions and/or service providers excluded, and the size of the encryption key.

6. A method according to claim 1, wherein the step of development of a set of candidates includes the random generation of each candidate, each service for each candidate satisfying the corresponding component of the service request.

7. A method according to claim 1, including the step of writing the connectivity links existing between the various services, to a memory location.

8. A method according to claim 1, wherein the service request includes at least one constraint forming a condition relative to the services corresponding to at least two distinct components of the said service request.

9. A method according to claim 8, wherein the constraints associated with at least two components of the service request include the constraints relating to the links between the nodes corresponding to each component, and/or the constraints of relative placement between the links and/or the nodes corresponding to each component.

10. A method according to claim 8, wherein the step of development of a set of candidates includes:
the selection of a predetermined percentage of candidates from among the candidates for which the cost function is the closest possible to an optimum, in order to form a parent-generation of candidates;
the computation of at least one new candidate from at least one candidate from the parent-generation, the computing including:
the selection of a candidate from the parent-generation;
for each service of the candidate selected from the parent-generation, associated with a component of the service request that does not include a constraint, the replacement of the service by a service selected in a random manner from among the services that satisfy the component;
for every other service, the replacement of the service by a service selected in a random manner from among the services that satisfy at least the same constraints of the component as the corresponding service of the candidate selected from the parent-generation.

11. A method according to claim 8, wherein the evaluation step includes the penalization of the overall score of a candidate if at least one constraint is not satisfied by a service of the candidate.

12. A method according to claim 1, wherein the evaluation step includes the penalization of the overall score of a candidate if, for at least one constraint that is not satisfied by a service of the candidate, the difference between the expected level of satisfaction and the level of satisfaction provided by the said service is greater than or equal to a threshold value, the threshold being defined by the service requester or calculated in accordance with the predetermined rules.

13. A method according to claim 1, including in addition, for each service, a step of writing to a memory location:
for each attribute i, of a mode of calculation of a rate of satisfaction x^{k}ᵢ;
for each attribute i, of a utility function uᵢ for the calculation of a score uᵢ(x,^{k},ᵢ) for the attribute for a given value of the satisfaction rate x^{k}ᵢ;
for each attribute i, of a suitable specific weight Φᵢ;
for each n-tuple of attributes {i, j, . . . }, of a joint weight I({i, j, . . . });
of the cost function, the cost function being of the following form:
$$C ( X ) = {\sum }_{I ( \{ i , j \} ) < 0} min ( {u}_{i} ( {x}_{i} ) {u}_{j} ( {x}_{j} ) ) \cdot I ( \{ i , j \} ) + {\sum }_{I ( \{ i , j \} ) < 0} max ( {u}_{i} ( {x}_{i} ) {u}_{j} ( {x}_{j} ) ) \cdot \vert I ( \{ i , j \} ) \vert + {\sum }_{i = 1}^{n} {u}_{i} ( {x}_{i} ) \cdot ( {φ}_{i} - \frac{1}{2} {\sum }_{j \neq i} \vert I ( \{ i , j \} ) \vert )$$
where min is the minimum operator, max is the maximum operator, X is a vector associated with a candidate, each element of the vector X corresponding to a service of the candidate and being equal to the rate of satisfaction of a component of the service request by the corresponding service, where xᵢ, xⱼ are respectively the rate of satisfaction of the component relative to the attribute i and of the component relative to the attribute j, and where uᵢ, is the utility function relative to the attribute i, Φᵢ is the specific weight relative to the attribute i, I({i,j}) the joint weight relative to the attributes i, j and |I({i,j})| denotes the absolute value of the joint weight I({i,j}).

14. A selection device for selecting at least one service to be provided by a telecommunication network from among a plurality of predetermined services, each service comprising at least one attribute, wherein the selection device comprises a computing means associated with a storage means in order to operationally implement the method according to claim 1.
